(19) United States
(12) Patent Application Publication
(10) Pub. No.: US 2022/0179937 A1
(43) Pub. Date: Jun. 9, 2022

(54) SECURE USER AUTHENTICATION SYSTEM AND METHODS

(71) Applicants: Jonatan Petho, Nyiregyhaza-Oros (HU); Tamas OLTMAN, Anaheim, CA (US); Aniko LADANYI, Miskolc (HU)

(72) Inventors: Jonatan Petho, Nyiregyhaza-Oros (HU); Tamas OLTMAN, Anaheim, CA (US); Aniko LADANYI, Miskolc (HU)

(21) Appl. No.: 17/436,024

(22) PCT Filed: Jun. 4, 2019
(86) PCT No.: PCT/US19/35314

§ 371 Date: Sep. 2, 2021

Related U.S. Application Data
(60) Provisional application No. 62/680,452, filed on Jun. 4, 2018.

(51) Int. Cl. G06F 21/36; G06F 21/60

(52) U.S. Cl. CPC G06F 21/36; G06F 2221/2103; G06F 21/604

(57) ABSTRACT

A user authentication system, wherein a user defines the rules that the system utilizes to generate a presentation matrix and corresponding solution password. Upon challenge with the generated presentation matrix, the system will authenticate the user only if the user enters the corresponding password for each presentation matrix.

### CROSS REFERENCE TO RELATED APPLICATIONS

This application claims priority from U.S. Provisional Patent Application No. 62/680,452, filed Jun. 4, 2018, which is incorporated herein by reference.

### FIELD OF THE INVENTION

The present invention relates to user authentication systems, specifically challenge-response based password generation systems.

### BACKGROUND

Securing and protecting access to data is a constant and ever-escalating arms race between those who seek to protect information and those who seek to illicitly access it. The well-documented weaknesses of standard passwords have led to the development of so-call “challenge-response” authentication systems. One such version, the presentation matrix authentication system (see e.g., U.S. Pat. No. 8,209,746 to Tamai) relies upon a user first creating a template, in which they select cells within a matrix in a specific order. During an authentication session, the system then presents a matrix filled with randomly generated numbers to the user, who must then enter the numbers present in the proper cells and proper order for the system to successful authenticate the user. Generally, the system uses the template prepared by the user to create a matrix generation ruleset, which is used to generate a presentation matrix and password pair for each authentication session.

The current presentation matrix password systems available today have several key limitations. First, the matrix generation ruleset is retained and stored for each user, such that the presentation matrix and password can be generated on demand. With this approach, a person with sufficient time and skill may be able to access the password derivation ruleset. With this information, the person would be able to masquerade as the user and gain access to the protected system. Additionally, the current presentation matrix systems are rudimentary in their design. For instance, they are only capable of presenting a single presentation matrix to the user at one time, they cannot perform mathematical operations within the matrix, and the presented information directly corresponds to the password that must be entered. Each of these drawbacks increases the likelihood that a person observing one or more successful authentication sessions would be able to derive the underlying password derivation ruleset.

### SUMMARY OF THE INVENTION

The above discussed disadvantages of the prior art are overcome by the user authentication system and methods of the present invention.

Thus, it is one aspect of certain embodiments of the present invention to provide a user authentication system wherein the user to be authenticated, during the registration process, defines a matrix and selects specific cells in a specific order in that matrix, which will serve as a “specimen” for the generation of a presentation matrix for user during the later authentication step. During said later authentication step, a generated presentation matrix will be shown to said user, who will need to enter the values shown in the selected cells in the selected order before the system will successfully authenticate the user. Due to the vulnerable nature of any computerized system, regardless of the level of encryption, the specimen will preferably not be stored or otherwise preserved after the initial generation of a preset number of presentation matrix/solution pairs. In certain embodiments the generated presentation matrix/solution pairs will be recycled at random should the user exhaust each original pair in the authentication process. More preferably, should the user exhaust the generated presentation matrix/solution pairs, the user will be prompted to generate a new specimen which in turn will be used to generate a new series of presentation matrix/solution pairs.

It is another aspect of certain embodiments of the present invention to provide a user authentication system based on a presentation matrix in which the system is capable of performing mathematical operations on the various cells within the presentation matrix. Thus, at the time of specimen generation, the user may indicate that more than one cell within the matrix, or one cell selected more than one time, must correspond to a certain digit (i.e., the first digit) within the final solution password. In such cases, the system would perform a preselected mathematical operation (i.e., addition, subtraction, multiplication, etc.) on the values of the numbers (or assigned values, in the case of symbols) in the chosen cells of the presentation matrix to derive the value of the digit to be entered in the final solution password. Preferably, this derived value would also appear in a cell of the presentation matrix, so that anyone observing the matrix and entered solution would be unable to immediately ascertain that a mathematical operation had been performed.

It is yet another aspect of certain embodiments of the present invention to provide a user authentication system comprising a value table. Such a value table would allow the user, at the time of specimen generation, to arbitrarily assign a value to any number or other symbol (including letters or shapes) that appears in the presentation matrix. As an example, during the specimen generation process, the user may indicate that the number “5,” when shown in the presentation matrix, would have an actual numerical value of “4.” Thus, if a 5 appears in the selected cell of the presentation matrix, the user would know to enter a 4 as the corresponding digit in the solution password. It will also be apparent that such altered values could be combined with the mathematical operations of the prior aspect to further complicate the ability of an observer to derive the specimen rules from an observed authentication session.

It is still another aspect of certain embodiments of the present invention to provide a user authentication system, wherein the system presents the user with numerous, sequential presentation matrixes, with each matrix in the sequence corresponding to a digit in the final solution password. In certain embodiments each of these sequential matrixes may a different number and arrangement of cells, different value tables, and different mathematical operations associated with them.

It is another aspect of certain embodiments of the present invention to provide a user authentication system, wherein, if the user enters an incorrect solution password in response to a presentation matrix, the user must then successfully complete the authentication process at least two times before the system will authenticate the user. It will be apparent that such a process will greatly reduce the likelihood of an unauthorized user from successfully “guessing” the password from an observed authentication session.

Thus, it is one embodiment of the present invention to present a system for authenticating a user, the system comprising: a datafile; wherein said datafile comprises a number of pre-generated presentation matrixes; wherein said pre-generated presentation matrixes comprise a series of at least one of numbers and symbols arranged in a pattern; wherein each of said number of pre-generated presentation matrixes is paired with a corresponding password solution; wherein said pre-generated presentation matrix/password solution pairs are generated utilizing a specimen prepared by the user and a ruleset algorithm; wherein said specimen prepared by the user is not saved post-generation; a user interface; wherein said user interface is configured to present a first of said pre-generated presentation matrixes to a user to be authenticated; wherein said user interface is configured to receive a first input password from said user to be authenticated; and wherein said system is configured to successfully authenticate the user only when said first input password matches said corresponding password solution for said first pre-generated presentation matrix.

It is another embodiment of the present invention to present such a system, wherein said specimen prepared by the user comprises a value table, wherein said value table comprises a numerical value associated with each of the at least one of numbers and symbols, and wherein said numerical value is specified by the user.

It is yet another embodiment of the present invention to present such a system, wherein said specified numerical value for at least one said numbers is different from the actual numerical value of said number.

It is still another embodiment of the present invention to present such a system, wherein said specimen prepared by the user indicates that a mathematical operation must be performed on at least one cell within the presentation matrix to produce the corresponding password.

It is yet another embodiment of the present invention to present such a system, wherein said mathematical operation is selected by the user at the time of specimen preparation.

It is still another embodiment of the present invention to present such a system, wherein each of said pre-generated presentation matrixes comprises a series of sequential presentation matrixes, wherein each of the series of sequential presentation matrixes corresponds to a digit of said corresponding password solution.

It is yet another embodiment of the present invention to present such a system, wherein said specimen prepared by the user comprises a different set of elements for each of said series of sequential presentation matrixes.

It is still another embodiment of the present invention to present such a system, wherein said system is configured to successfully authenticate the user only when a second input password matches said corresponding password solution for a second pre-generated presentation matrix and a third input password matches said corresponding password solution for a third pre-generated presentation matrix, if said a first input password does not match said corresponding password solution for a first pre-generated presentation matrix.

These, and other, embodiments of the invention will be better appreciated and understood when considered in conjunction with the following description and the accompanying figures. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### DESCRIPTION OF THE FIGURES

FIG. 1. Illustrative example of matrix definition.

FIG. 2. Illustrative example of password definition.

FIG. 3. Illustrative example of presentation matrix and corresponding password.

FIG. 4. Illustrative example of an enhanced matrix/password definition.

FIG. 5. Illustrative example of enhanced password entry.

### DETAILED DESCRIPTION OF THE INVENTION

Unless otherwise defined, all terms used herein have the same meaning as commonly understood by one of ordinary skill in the art to which this invention belongs. Methods and materials are described herein for use of the present invention; other suitable methods and materials known in the art can also be used. The materials and methods, and examples are illustrative only and not intended to be limiting. All publications, patent applications, patents, and other references mentioned herein are incorporated by reference in their entirety. In case of conflict, the present specification including definitions will control.

The term “specimen” refers to a user-generated template which serves as the basis, or seed, to generate the presentation matrix/solution pairs. The specimen may a number of elements, including but not limited to: the size and shape of the presentation matrix; the number of presentation matrixes and the digits in the final password to which they correspond; a value table; and any mathematical operations to be performed.

A “value table” refers to a listing of the true numerical value, assigned by the user, that corresponds to any presented digit, letter, or symbol present in the presentation matrix.

The phrase “selecting at least one of a group consisting of X and Y” refers to situations where X is selected alone, Y is selected alone, and where both X and Y are selected together.

Matrix/Password Generation:

The system of the present invention has been developed to successfully authenticate a user prior to allowing access to a computer or other device, or in any situation where a password restriction is viable such as restricted-access buildings, rooms, safes, and vaults. When a user to be authenticated first uses the system of the present invention, the user will be prompted via a user interface to prepare a specimen, which will be used by the system to generate a series of presentation matrix/password pairs. The specimen prepared by the user will dictate the elements of the presentation matrix, including, but not limited to, the following: 1) the number of cells in the presentation matrix; 2) the arrangement of the cells of the presentation matrix; 3) whether numbers, letters, or other symbols may appear in the presentation matrix; and 4) a value table, indicating the true numerical value that will be assigned to any numbers, letters, or symbols that may appear in the presentation matrix. The user will also select the final password length, and the cells within the defined presentation matrix that will correspond to a digit in the final solution password. For each digit in the final solution password, the user may indicate the following: 1) The specific cell that corresponds to the specific final digit; 2) whether multiple cells must correspond to a specific digit, and if so, what mathematical operation must be performed on those cells; and 3) Whether a mathematical operation must be performed on the value present in a single selected cell, and what that operation must be.

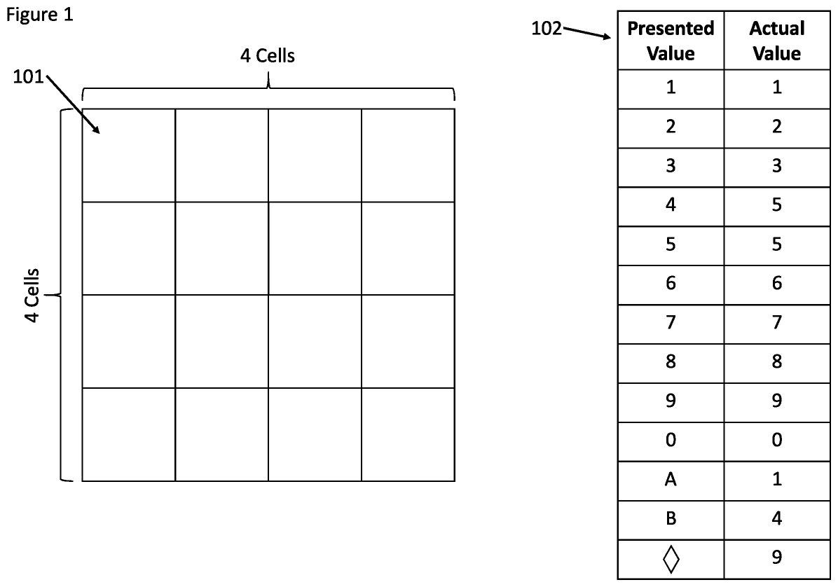

FIG. 1 illustrates one example of the matrix definition step described above. In this illustrative example, the user has selected a four by four presentation matrix (101). In value table for this matrix (102), the user has elected to keep the value of every digit the same except for the number 4, which when presented will have an actual numerical value of 5, and to assign an actual numerical value of 1 to the letter A, 4 to the letter B, and 9 to the diamond symbol.

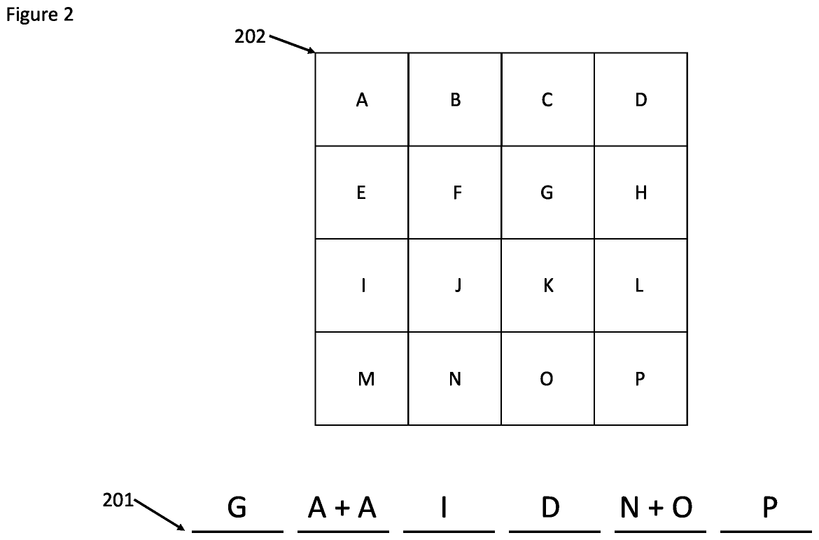

FIG. 2 illustrates one example of the password definition step described above. In this illustrative example, the user has selected a final password solution length of six digits (201). Here, the first digit corresponds to cell G in the presentation matrix (202); the second digit corresponds to cell A added to itself; the third digit corresponds to I; the forth digit corresponds to cell D; the fifth digit corresponds to the sum of cells N and O; and sixth digit corresponds to cell P. Preferably, in the event that a given mathematical operation would result in a number with more than one digit (i.e., a two or three digit number) then the user would only need to enter the digit in the ones column of that number into the password entry field. Using the above inputs as an example, if the presentation matrix contained a 9 in cell A, then result of adding A to itself would be 18. As the digit in the ones column of 18 is the number 8, the number 8 would be entered into the password entry field for the second digit of the password.

Once the user is satisfied with the prepared specimen, in certain embodiments the system of the present invention will then utilize a matrix generation algorithm to generate a series of presentation matrixes and their corresponding password solution pairs. Preferably, the system will employ a validation step to ensure that weak or easily solvable matrixes are not generated at this step. For example, to ensure that a solution digit does not only appear once in a given matrix, which would reveal the actual cell from the specimen for that digit to an observer. Thus, if the user has elected to not have a mathematical operation used to derive the final password solution, the system must only ensure that each value present in the final solution password appears at least twice in the presentation matrix. However, should the user elect to have such a mathematical operation performed within or among the cells of the matrix, the system will preferable preform a more complex validation. For example, the presentation matrix generating algorithm of the user authentication system may ensure that every value present in the value table appears in the presentation matrix at least once and that the solution to the mathematical operation also appears in the matrix at least once.

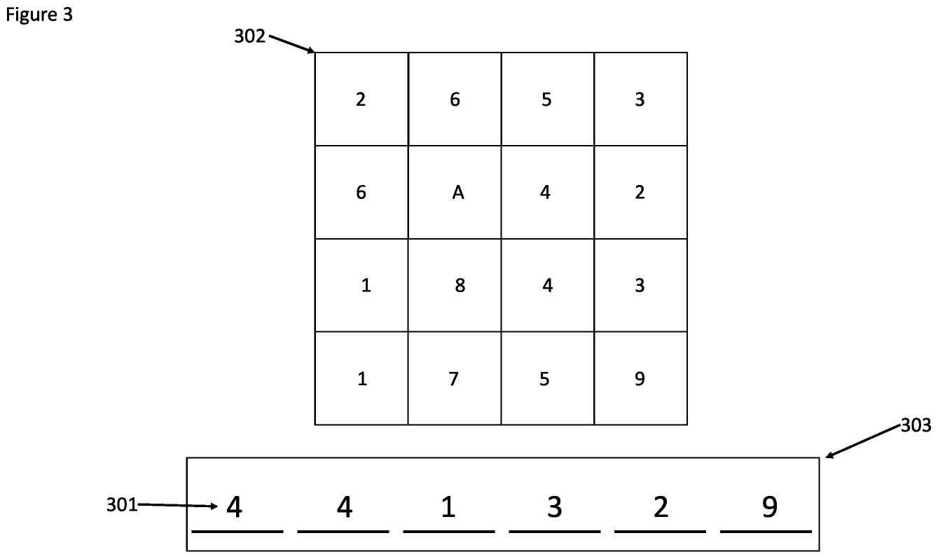

The presentation matrix generation algorithm will preferably generate a preset number of validated presentation matrix/solution pairs. One example of presentation matrix/solution password pair (corresponding to the above-described example) is presented in FIG. 3. To be successfully validated by the system, the user would need to derive the correct password (301) (using the rules he or she devised in the specimen creation process) from the given presentation matrix (302), and enter those digits into the password entry field (303) of the system.

Preferably, the specimen is then deleted or otherwise erased, to prevent it from being used by unauthorized third parties to circumvent the user authentication system. However, in certain use cases, it may preferable to save the specimen for later use.

The generated presentation matrix/password solution pairs will preferably be stored as an encrypted datafile. The type and stringency of the encryption method will vary depending on the use case, and the types of encryption useful in the present system are well known in the art. Preferably, each datafile will be unique to a specific user. Depending upon the use case, the datafile may be stored in a client installed on the device to which the user is seeking access, on a remote server, or some combination of the two. In the event that the datafile is stored on a remote server, the client must be configured to communicate with the server via some form of electronic transmission.

Enhanced Authentication System:

In certain embodiments of the present invention, and enhanced version of the above-described system may be employed. In the enhanced version, during specimen generation, the user may indicate that they wish to have a different matrix correspond to each digit of the final password. Thus, if the password is four digits long, the user would be presented with four sequential presentation matrixes, which would cycle as the user entered each digit of the password. Each matrix in this embodiment would be governed by its own specimen ruleset, and as such could be different sizes, have different value tables, and utilize different mathematical operations. In such a case, the matrix generation algorithm would operate in much the same way as the standard version of the system, however the resulting presentation matrix/solution pairs would comprise an ordered series of presentation matrixes, instead of only one per pair.

User Authentication:

In various embodiments of the present invention, once the presentation matrix/password pairs have been generated, the system may be used to authenticate the user, thus allowing access to the device on which the system is installed, or any other use case in which authentication is desired. During the authentication process, the system will present the user, via the user interface, with one of the pre-generated presentation matrixes from the stored datafile. Using the rules that user devised during the creation of the specimen, the user may decipher the presentation matrix and enter the corresponding digits into password input field of the system. If the password entered by the user matches the stored password for the given presentation matrix, then the system will successfully authenticate the user. If the entered password does not match the stored password for the given presentation matrix, then authentication will fail. Consequences for failed authentication will necessarily depend on the use case.

Should the user fail enter a correct password for the given presentation matrix, in certain embodiments, the system may require a heightened level of verification to successfully authenticate the user on repeated attempts. Such heightened levels of verification may include (but are not limited to), needing to successfully enter passwords in two consecutive rounds of presentation matrix challenges, use of some form of two-factor authentication, or pairing a successful password entry to a subsequent presentation matrix challenge with authorization from another authenticated user.

### Working Example 1

A corporation uses the user authentication system of the present invention to prevent unauthorized access to its internal servers. A new hire is authorized by the corporation to allow such access. In preparing the specimen, the new hire chooses a 6×6 matrix, does not alter any values in the value table, and elects to have a password that is four digits long. The new hire then selects the four indicated cells of the matrix, in the numbered order shown, to correspond to the digits of the password. Because no mathematical operations were selected by the new hire, the system then generates a series of presentation matrix/password pairs that satisfy the matrix strength validation parameters set by the owner of the system (in this case, the corporation). Because the corporate server system is entirely self-contained, with no access to outside systems, the datafile housing the matrix/solution pairs is generated and stored by the authentication system entirely on-site.

When the new hire then wishes to access the corporate servers, the authentication system presents the new hire with one of the pre-generated presentation matrixes. If the new hire deciphers the presentation matrix and enters a password that matches the stored solution password, the system will authenticate the new hire and allow her access to the system.

### Working Example 2

A bank uses an embodiment of the authentication system of the present invention to verify users prior to allowing access to account information on a mobile device. The bank's mobile application allows users to generate the specimen on their mobile device. Due to the sensitive nature of financial data, the bank requires users to use an enhanced version of the authentication system of the present invention. In the enhanced version, the system will require the user prepare a different specimen for each digit of the final password. As such, the user may choose different matrix sizes, value tables, and mathematical operations for each digit of the password, thus greatly enhancing the security of the system. When the user enters the password, the presentation matrix would appear to refresh or change (with different numbers and/or symbols appear in each cell) as each digit is entered.

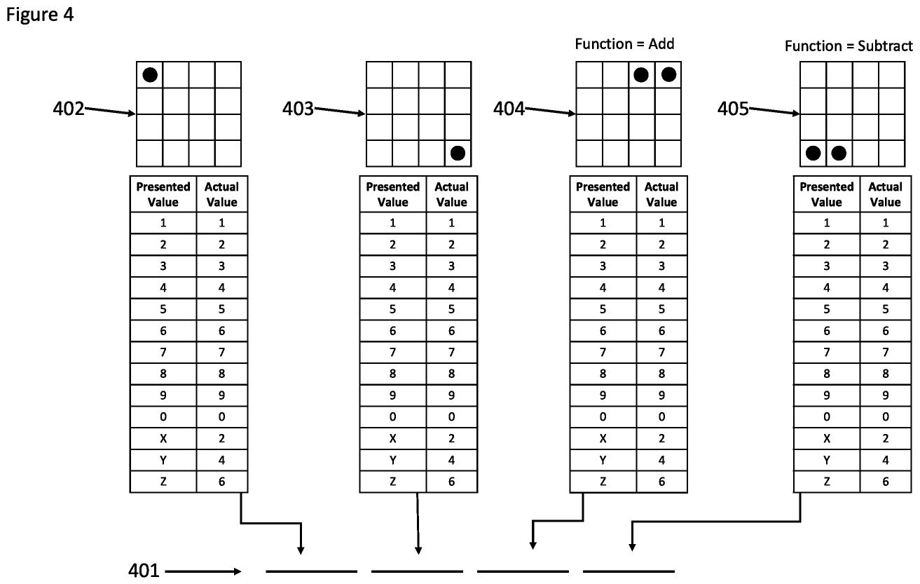

Here, the user selects a 4 digit password (401) as illustrated in FIG. 4, and thus must enter the parameters for four separate matrixes (402, 403, 404, and 405), one for each digit. The user selects a 4×4 matrix for each digit of the password and chooses to have the same value table for each matrix, which includes the characters X, Y, and Z (assigned values of 2, 4, and 6 respectively). For the first digit, the user selects the top, left cell; for the second digit, she selects the bottom, right cell; for the third digit, she selects the two top left squares added together; and for the fourth digit she selects the two leftmost squares on the bottom row, subtracted from each other (preferably, the system will always have this operation be represented as a positive number).

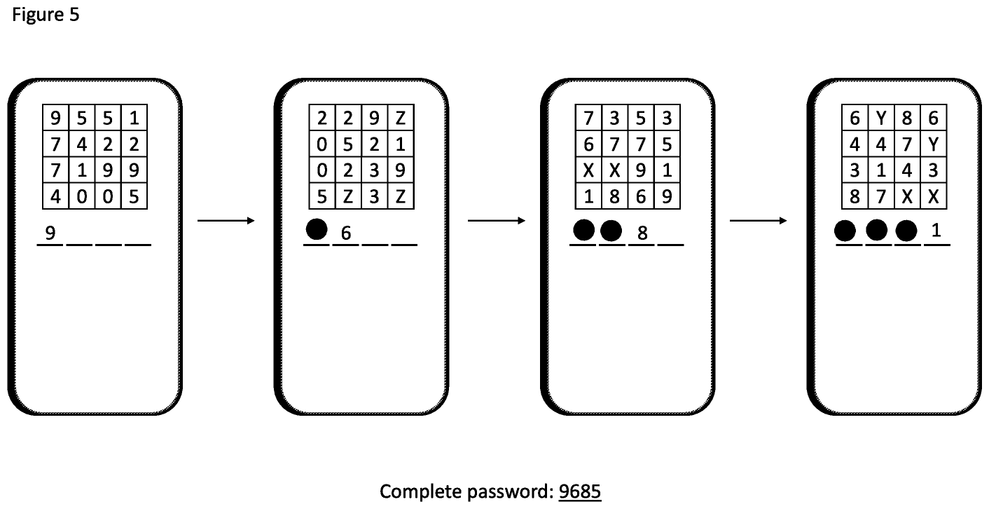

The matrix generation algorithm of the present invention then uses the specimens prepared by the user to generate valid presentation matrix/password pairs for the user, which in this enhanced case would comprise a series of four sequential matrixes for each corresponding solution password. The datafile housing these pairs is stored on the bank's servers. When the user makes a login attempt to access her financial data, the bank transmits one encrypted presentation matrix pair to the user's device, where the client running on the device decrypts the pair in order to progress with the authentication session. As illustrated in FIG. 5, the client then presents the user with the first of the sequential presentation matrixes via the user interface on the device. The user deciphers the first presentation matrix and enters the first digit in the password entry field. The system then presents the user with the second sequential presentation matrix. The user deciphers the second presentation matrix and enters the second digit, which results in the third presentation matrix being display, followed by the forth in similar fashion. If the four digits entered match the stored password solution, the system authenticates the user and allows access to the user's financial data.

In an alternate version of the above embodiment, the client on the user's mobile device may store a datafile, on which is stored a small number of the pre-generated matrix/solution pairs, which would remove the need for the system to transmit the matrix/solution pair to the client for each login attempt. This datafile may then be updated with a new set of matrix/solution pairs after each successful login attempt, after the user has been successfully authenticated.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible, and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

We claim:

1. A system for authenticating a user, the system comprising:
i. a datafile;
a. wherein said datafile comprises a number of pre-generated presentation matrixes;
b. wherein said pre-generated presentation matrixes comprise a series of at least one of numbers and symbols arranged in a pattern;
c. wherein each of said number of pre-generated presentation matrixes is paired with a corresponding password solution;
d. wherein said pre-generated presentation matrix/password solution pairs are generated utilizing a specimen prepared by the user and a ruleset algorithm;
e. wherein said specimen prepared by the user is not saved post-generation;
ii. a user interface;
a. wherein said user interface is configured to present a first of said pre-generated presentation matrixes to a user to be authenticated;
b. wherein said user interface is configured to receive a first input password from said user to be authenticated; and
iii. wherein said system is configured to successfully authenticate the user only when said first input password matches said corresponding password solution for said first pre-generated presentation matrix.

2. The system of claim 1, wherein said specimen prepared by the user comprises a value table, wherein said value table comprises a numerical value associated with each of the at least one of numbers and symbols, and wherein said numerical value is specified by the user.

3. The system of claim 2, wherein said specified numerical value for at least one said numbers is different from the actual numerical value of said number.

4. The system of claim 1, wherein said specimen prepared by the user indicates that a mathematical operation must be performed on at least one cell within the presentation matrix to produce the corresponding password.

5. The system of claim 4, wherein said mathematical operation is selected by the user at the time of specimen preparation.

6. The system of claim 1, wherein each of said pre-generated presentation matrixes comprises a series of sequential presentation matrixes, wherein each of the series of sequential presentation matrixes corresponds to a digit of said corresponding password solution.

7. The system of claim 6, wherein said specimen prepared by the user comprises a different set of elements for each of said series of sequential presentation matrixes.

8. The system of claim 1, wherein said system is configured to successfully authenticate the user only when a second input password matches said corresponding password solution for a second pre-generated presentation matrix and a third input password matches said corresponding password solution for a third pre-generated presentation matrix, if said a first input password does not match said corresponding password solution for a first pre-generated presentation matrix.
